(19) United States
(12) Patent Application Publication
(10) Pub. No.: US 2004/0228404 A1
(43) Pub. Date: Nov. 18, 2004

(54) Moving picture coding method

(75) Inventors: Jae Shin Yu, Seoul (KR); Joo Min Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/842,502

(22) Filed: May 11, 2004

(30) Foreign Application Priority Data
May 12, 2003 (KR) 2003/29855

(51) Int. Cl. H04N 7/12

(52) U.S. Cl. 375/240.03; 375/240.27; 375/240.01; 375/240.2

(57) ABSTRACT

There is provided a moving picture coding method, which is capable of effectively processing error concealment through data hiding. The moving picture coding method includes the steps of: extracting a picture header information of an inputted image at an encoder; transmitting the extracted picture header information through data hiding; and performing an error concealment using the transmitted picture header information at a decoder.

### BACKGROUND OF THE INVENTION

1. Field of the Invention

The present invention relates to a moving picture coding method, and more particularly, to a moving picture coding method, which is capable of efficiently processing error concealment through data hiding.

2. Description of the Related Art

As very high speed mobile communications such as TMT-2000 are visualized, multimedia services such as voice, still picture and moving picture are widely expanded. Examples of the moving picture multimedia services are one-way service such as VOD and bi-directional service such as video communication. Video communication basically performs a video compression because it has a larger quantity of data than the voice communication.

A moving picture coding method according to the related art will now be described with reference to FIG. 1. Referring to FIG. 1, motion estimation and motion compensation are performed to an input image to extract motion vector. Then, discrete cosine transform (DCT) and quantization are performed to a difference image. Variable length coding (VLC) is performed to the quantized data in order for more efficient data compression.

An original image is restored by adding the previous image and the inverse quantized and inverse DCTed image. A difference image of next image is obtained using the restored image. In this manner, video data compression is achieved.

After the video data compression, a communication with the other party is performed through a network. At this point, noise occurs in the data transmission network. In other words, communication data are not intactly transmitted to a receiver terminal, and data damage or loss occurs. Such damage or loss of the transmission data is referred to as error.

Such an error has an influence on corresponding error frame and following frames. The reason is because the compression is performed to video data. In spatiotemporal motion estimation, one time occurrence of data error affects consecutive frames. Additionally, when data error occurs, the variable length coding loses synchronization (Sync) and affects the frames until next synchronization is found. In other words, due to the video compression, the degradation of picture quality according to the data loss becomes very serious and occurs consecutively.

Specifically, loss of header information containing an entire information of data compression has greater influence on the picture quality than that of data information. According to general video compression, one image is divided into several layers ad each layer includes a header to contain common information of lower layers. Therefore, in case a header of a certain layer is broken, all information on the lower layers are lost, resulting in serious degradation of the picture quality.

Such degradation of picture quality is a great obstacle to the moving picture services. While error recovery and error concealment methods are provided in video compression standard, the respective methods have limitations.

The error recovery methods are mainly performed through an additional data embedding at an encoder. When an error occurs, error propagation can be prevented at a decoder. In other words, the error propagation can be prevented by additionally embedding synchronization bits into the encoding streams or by segmenting the streams into blocks with the same length. Such an error recovery method has a disadvantage in that the decoding cannot be performed if the decoder does not know the error recovery method of the encoder.

Another error recovery method is to operate a coder and decoder at the same time. This method uses a back channel. If the decoder notifies the encoder of a position where an error occurs, the encoder performs an error recovery using the information (that is, the position where the error occurs). This method has a disadvantage in that a system must additionally support the back channel.

Meanwhile, the error concealment method is performed at the decoder. According to this method, the region where as error occurs is made to be maximally similar to the original image using an image contained in the decoder. In this case, there is a limit in accuracy of the error concealment because the error concealment is performed using only the limited information at the decoder.

However, the above-described error recovery and concealment methods have disadvantages in that all errors are not eliminated.

### SUMMARY OF THE INVENTION

Accordingly, the present invention is directed to a moving picture coding method that substantially obviates one or more problems due to limitations and disadvantages of the related art.

An object of the present invention is to provide a moving picture coding method, in which picture header information is provided through data hiding in an encoding process when multimedia images are transmitted through a network, thereby efficiently processing error concealment with respect to an error occurring in a decoding process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a moving picture coding method of a moving picture transmission system includes the steps of: extracting a picture header information of an inputted image at an encoder; transmitting the extracted picture header information through data hiding; and performing an error concealment using the transmitted picture header information at a decoder.

The moving picture coding method may further include the step of extracting the picture header information from the data hiding at the decoder before the error concealment is performed.

The picture header information may include a structural information of encoding picture header and a header information that changes every time in an encoding process. The structural information of the encoding picture header may include an information about whether the picture header is extended or not. The header information that changes every time in the encoding process may include quantization parameter (PQUANT) of a corresponding picture and a temporal reference value, in which the temporal reference value is a picture information to which the corresponding picture refers.

Preferably, the data hiding hides the extracted picture header information in next frame from a frame which the picture header information is extracted from.

The error concealment may include the steps of: checking whether or not an error occurs in the picture header of an inputted N-th frame; if the error occurs in the picture header of the inputted N-the frame, storing corresponding picture data in a buffer, and decoding picture data of a (N+1)-th frame to extract a picture header information of the N-th frame; and decoding the picture data of the N-th frame with reference to the extracted picture header information of the N-th frame, the picture data of the N-th frame being stored in the buffer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view of a related art coding process;

FIG. 2 is a view of a picture layer in a related art moving picture coding method;

FIG. 3 shows an influence in case an error occurs in header of each layer;

FIG. 4 is a view of a data hiding using a quantization parameter in a moving picture coding method according to the present invention;

FIG. 5 is a view of a data hiding using a level value in a moving picture coding method according to the present invention

FIG. 6 illustrates a structure of a picture header to which data hiding is performed in a moving picture coding method according to the present invention;

FIG. 7 is an exemplary view illustrating a structure of a parameter set of a picture header to which data hiding is performed in a moving picture coding method according to the present invention;

FIG. 8 is a view illustrating a picture header information in which data hiding is performed in a moving picture coding method according to the present invention;

FIG. 9 is a flowchart illustrating a coding process of an encoder in a moving picture coding method according to the present invention; and

FIG. 10 is a flowchart illustrating a coding process of a decoder in a moving-picture coding method according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

According to the present invention, picture header information is imperceptibly transmitted through data hiding in an encoding process. Therefore, in case an error occurs, an error concealment is processed more effectively at a decoder.

As is well known, video data in a video picture communication are compressed and transmitted because they have a large amount of data. If all video data are compressed, an amount of compressed data is also large. Therefore, a portion similar to a previous image is found to obtain a motion vector. Then, only its difference value is encoded and a variable length coding (VLC) is performed.

If video data are compressed in this manner, a large amount of data compression can be achieved. However, if an error occurs, an error is propagated. In other words, since the compression is performed through the variable length coding, even when an error occurs in one bit the error occurs consecutively until next synchronization (sync) is found. Since the encoding is performed with reference to the previous image, the error is propagated to next images if the error occurs in the previous image.

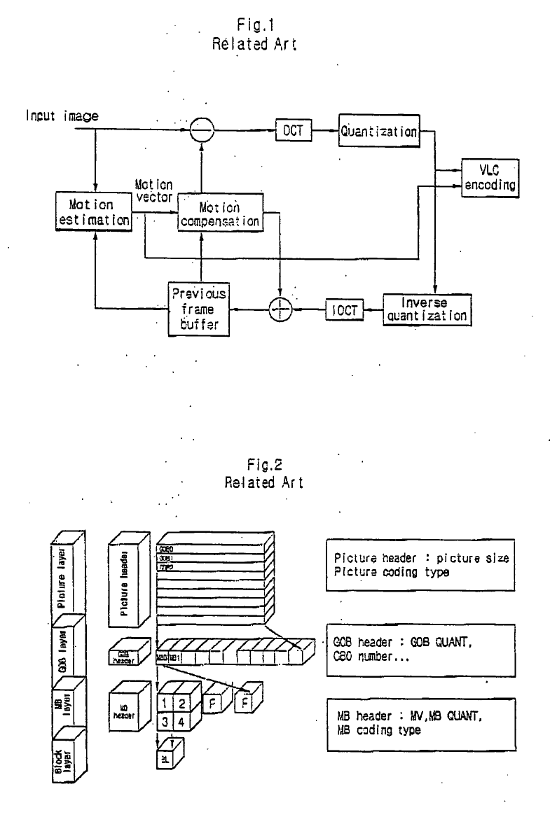

In a general video compression method of compressing video data through motion estimation and motion compensation, image is divided into layers and the compression is performed using the divided layers. If the layers are used, common information of the lower layers can be contained in the header. FIG. 2 illustrates a hierarchical structure of H.263 video compression standard.

Referring to FIG. 2, the hierarchical structure includes four layers, that is, picture layer, group of block (GOB) layer, macroblock (MB) layer, and block layer. The picture means one frame and includes nine GOBs. The GOB means one string of block unit and includes eleven macroblocks. The macroblock is unit for finding motion vector and includes four luminance blocks and two chrominance blocks. The block is a basic unit of the data compression and includes 8×8 pixels.

In more detail, each layer includes header that represents a structural information of its lower layer. Picture header contains information relating to one whole frame, such as an encoding type of picture, a usage of an additional mode, a reference frame number and a size of image. GOB header contains GOB start code, GOB number, and frame ID. In other words, the GOB header contains information on one string of macroblock unit. Macroblock header contains information on motion vector, macroblock encoding type, and so on by 16×16 pixel unit.

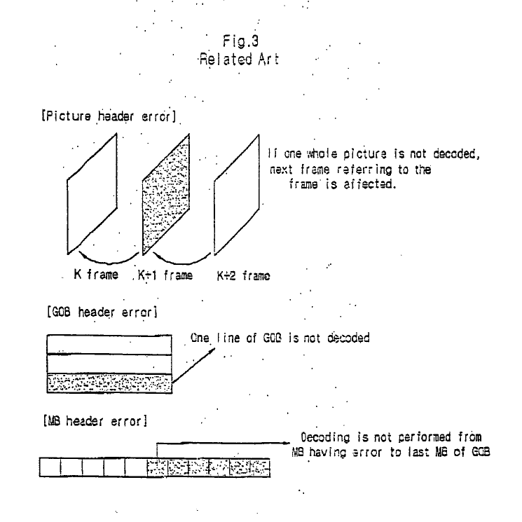

As described above, each layer includes its own header containing the structural information of its lower layer. In case an error occurs in the header of each layer in the video communication environment, the picture quality is degraded more seriously than the case an error occurs in the data. FIG. 3 shows an influence in case an error occurs in the header of each layer.

Referring to FIG. 3, when an error occurs in the picture header that is the highest layer, it is impossible to decode one whole frame, thus causing a serious degradation of the picture quality in next frame that refers to the frame having an error. Specifically, the picture quality is degraded more seriously if the previous image is not referred when motion is large.

In addition, if an error occurs in the GOB header, one GOB line cannot be normally decoded. If an error occurs in the macroblock header, a normal decoding is not performed from the corresponding macroblock to the last macroblock.

In order to prevent such a degradation of the picture quality, data hiding technology is used to hide the picture header information in the encoding data and transmit it, thus recovering the error.

The data hiding will now-be described below.

Data hiding is a technology that hides information in digital multimedia and, if necessary, extracts the hidden information. The data hiding can be largely classified into two categories. One requires an original image and the other does not require an original image when the hidden information is extracted. The data hiding that does not require the original image is be used in this invention.

In this invention, the data hiding is performed in the video compression. When the input image is compressed, the data hiding can be performed using parameters, which are used in the data compression, or by changing values that are dependent on the input image. In order to achieve the data hiding in the video compression, there must be values that do not affect the picture quality or amount of compressing data, even if original parameter or data are changed through the data hiding. Such values are quantization parameter (QP) and “level” value. The level value is given by dividing DCT coefficient by quantization parameter.

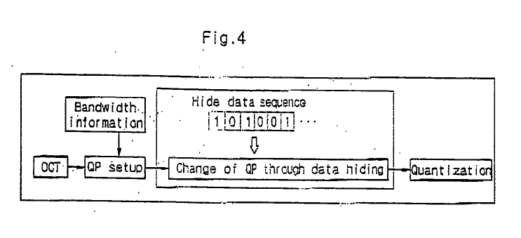

FIG. 4 illustrates the data hiding using the quantization parameter in the moving picture coding method according to the present invention.

As is well known, it is the quantization parameter that adjusts an amount of encoding data. The quantization parameter is a parameter that is used to divide the input image or its difference value by DCT coefficient. If the quantization parameter increases, a value divided by the DCT coefficient becomes large, so that an amount of the encoding data decreases. On the contrary, if the quantization parameter decreases, a value divided by the DCT coefficient becomes small, so that an amount of the encoding data increases.

When the video moving pictures are received and transmitted through a network, data are compressed to match with bandwidth of the network. If the bandwidth of the network is wide, an amount of communication data becomes large, so that an encoding amount increases and thus the picture quality is improved. On the contrary, it the bandwidth of the network is narrow, an amount of communication data becomes small, so that an encoding amount decreases and thus the picture quality is degraded. Considering these network conditions, the amount of the encoding data is adjusted using the quantization parameter. At this point, the data hiding is performed

Referring to FIG. 4, the discrete cosine transform (DCT) is performed to the input image or its difference image and then an appropriate quantization parameter is set, considering the bandwidth of the network. The quantization parameter is used to decode the compressed image after entering a macroblock header. At this point, the data hiding is performed before the quantization is carried out using the quantization parameter. Here, the data hiding can be performed as follows:

QP_new %2==Hide bit [k]

QP_new: No change

QP_new %2 !=Hide bit [k]

QP_new=QP_new+1;

Hide bit [k]: bit stream of data to be hidden

If the data hiding is performed in the above manner, the hidden data can be extracted based on the quantization parameter while the decoder decodes the compressed data. If the quantization parameter in the decoder is an even number, the hidden data becomes “0”, and if the quantization parameter is an odd number, the hidden data becomes “1”.

At this point, the quantization parameter is slightly changed at the encoder in order for the data hiding. In other words, when the data to be hidden and the quantization parameter are divided by 2, if the remainders are equal to each other, the value of the quantization parameter increases by 1, thereby making the remainders equal to each other. In this case, the divisor of the DCT coefficient increases, so that an amount of the encoding data is reduced. However, human's eyes cannot almost recognize the degradation of the picture quality.

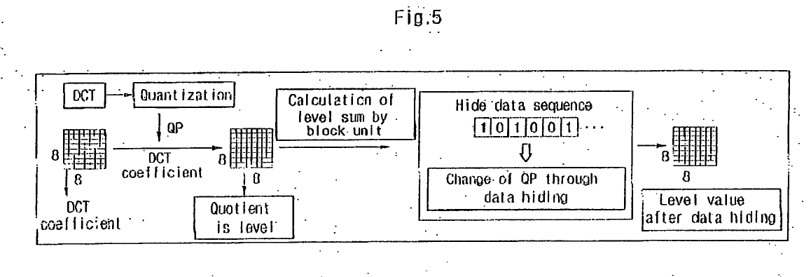

FIG. 5 is a view of a data hiding process using the level value in the moving picture coding method according to the present invention. In other words, in FIG. 5, data hiding is performed to the “level” value, which is given by quantizing the DCT coefficient of the input image or difference image.

According to the moving picture coding method of the present invention, the DCT is performed to the input image or difference image for the purpose of compression. Then, considering the transmission bandwidth, the quantization parameter is assigned to adjust an amount of encoding bit. The DCT coefficient is divided by the quantization parameter.

In FIG. 5, the DCT is performed by 8×8 block unit. The quantization parameter is applied to the DCTed block and the coefficient is divided. When the coefficient is divided by the quantization parameter, the resultant quotient is referred to as “level”. The data hiding is performed using the levels produced at each block. Here, the data hiding can be expressed as follows:

LevelSum %2==Hide Bit [k]

Level: No change

LevelSum %2 !=Hide Bit [k]

A value of a level having the lowest significance decreases by 1

Levelsum: Sum of all levels of blocks.

The reason why the data hiding is performed not in the respective levels but in the sum of levels by block unit is that the picture quality is affected when the data hiding is performed to the respective levels. As the quantization parameter becomes larger, one level's range of DCT coefficient becomes wider, because the level is the quotient of the value given by dividing the DCT coefficient by the quantization parameter.

For example, in case the level values are equal to 1, if the quantization parameter is 10, the available DCT coefficient ranges from 10 to 19, and if the quantization parameter is 30, the available DCT coefficient ranges from 30 to 59. Thus, when the sum of the levels is calculated by 8×8 block unit and divided by 2, if the resultant remainder and the data bit to be hidden are equal to each other, the level is not changed, and if not, a value of a level having the lowest significance decreases by 1.

Here, the level having the lowest significance represents a region having the least sensitivity to human's eyes. Meanwhile, human's eyes are least sensitive to high frequency range. Therefore, if the data bit to be hidden and the remainder made by dividing the “level sum” by 2 are not equal to each other, the value of the level having the highest frequency decreases by 1.

If the “level sum” is “16” and the bit to be embedded is “1”, the value or the “level” corresponding to the highest frequency block among the blocks decreases by “1”. Thus, the “level sum” becomes “15”, so that the bit to be hidden and the remainder given by dividing the “level sum” by 2 are made to be equal to each other.

However, a problem occurs when the “level sum” is “1”. If the “level sum” is “1” and the bit to be hidden is “1”, a sum of the total blocks becomes “0” when the level value of the region having the lowest sensitivity decreases by 1. However, since the level of the block whose original sum is “0” cannot be decreased any more, the data hiding is not performed. In this case, the block whose “level sum” is charged from “1” to “0” through the data hiding cannot be distinguished from the block whose original “level sum” is “0” and having no data hiding.

The present invention makes use of a following method in order to prevent these errors.

In case the “level sum” is “1” and the data to be hidden is “1”, data is embedded into the corresponding block. In this case, the “level sum” is not changed. In case the “level sum” is “1” and the data to be hidden is “0”, the “level sum” of the corresponding block is changed to “0” and the data hiding is not performed. When the “level sum” is “0”, the decoder considers that there is no data hiding in the corresponding block.

In this manner, if the data to be hidden and the remainder made by dividing a sum of the blocks by 2 are equal to each other, the levels of all the blocks except for the block having the “level sum” of “1” are not changed, and if not, the data can be hidden by decreasing the level of the region having the lowest sensitivity by 1.

In case of the block having the “level sum” is “1”, if the data to be hidden is “1”, the data is hidden. On the contrary, if the data to be hidden is “0”, the data is not hidden, but only the level value of the block is changed to “0”. When the “level sum” is “0” the data hiding is not performed.

Meanwhile, when the data hiding is performed using the quantization parameter or the level value, the data hiding is performed to the picture header information.

However, since the whole picture header information cannot be hidden and transmitted, only information that is necessary for decoding the picture among the picture header information is condensed to make parameter set. The parameter set and important information for the decoding, although not condensed, are bound to perform the data hiding.

Here, the parameter set of the picture header is a value that represents a structural characteristic of the picture header and header information, which is not changed every time among the important information of the picture header in the encoding. Referring to FIG. 6, the picture header has three structures. The structure of the picture header is determined according to values that represent an expansion of the picture header within the picture header. “PTYPE” has the most basic value of the picture. If sixth to eighth bits of the PTYPE are not “111”, the picture header becomes the most basic 50-bit header that is not extended.

If the sixth to eighth bits of the PTYPE is “111”, the picture header is extended. The extended header is classified into two types. At this point, the value of the extended picture header is changed depending on whether a value of update full extended PTYPE (UFEP) following the extended PTYPE is “001” or “000”. If the value of the UFEP is “001”, optional part of PLUSPTYPE (OPPTYPE) and mandatory part of PLUSPTYPE when PLUSPTYPE present (MPPTYPE) are added, and if the value of the UFEP is “000”, MPPTYPE is added.

If the value of the UFEP is “001”, it means that the extended PTYPE is all contained in a current header and represents how all extension option is. If the value of the UFEP is “000”, it means that an extension portion, which must be contained in all picture headers, is included.

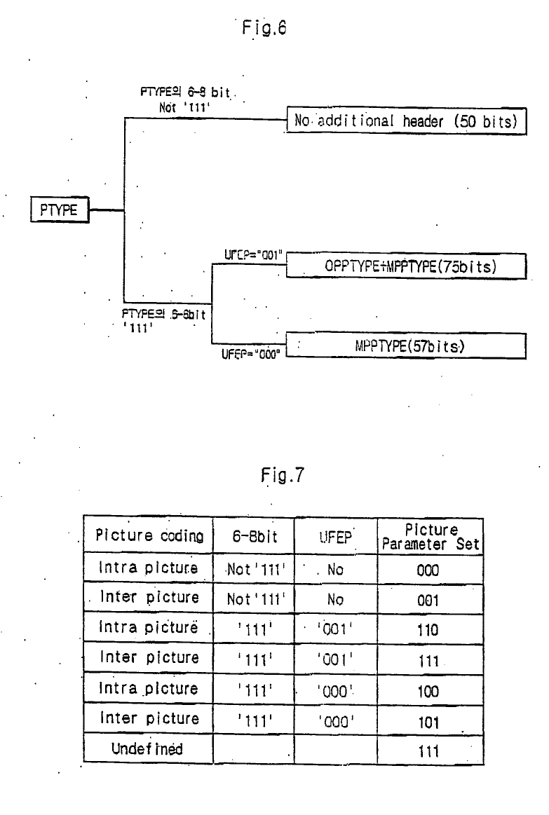

When the sixth to eighth bits of the PTYPE are “111”, the value of the UFEP must be “001” once per five seconds or every five picture headers. In most of the video compression, the picture header has a fixed parameter value. The picture header is characterized in that it has a value almost similar to the previous picture header, except only when an additional “annex” is used or an extension mode of the UFEP is changed. Considering this point, the parameter set of the picture header is established. The parameter set of the picture header is shown in FIG. 7. FIG. 7 is an exemplary view illustrating the parameter set of the picture header to which the data hiding is performed in a moving picture coding method according to the present invention.

In this invention, six parameter sets of the picture header are defined using three structures based on the extension of the picture header and two picture types (that is, intra picture and inter picture). The parameter sets of the picture header cannot express all picture header information. The reason is because there are header values that change at each picture. Such header values are “PQUANT” value and “temporal reference” value.

Here, the “PQUANT” value is a quantization parameter value of the picture. As long as the quantization parameter value is not changed in the lower layers, all pictures have the “PQUANT” value as the quantization parameter value. Since this value changes at each picture, it is not contained in the parameter set of the picture header. However, it is an important header value that must be transmitted using the data hiding.

The “temporal reference” value is also an important header value that must be separately transmitted. The “temporal reference” is to transmit picture number of a picture to which a current picture refers. If the reference picture is changed, the picture quality is degraded seriously. Therefore, an accurate information transmission is required.

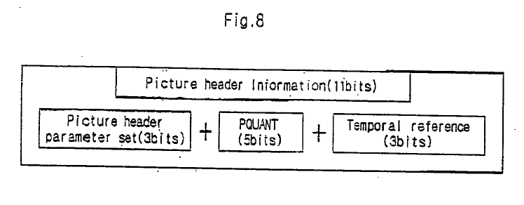

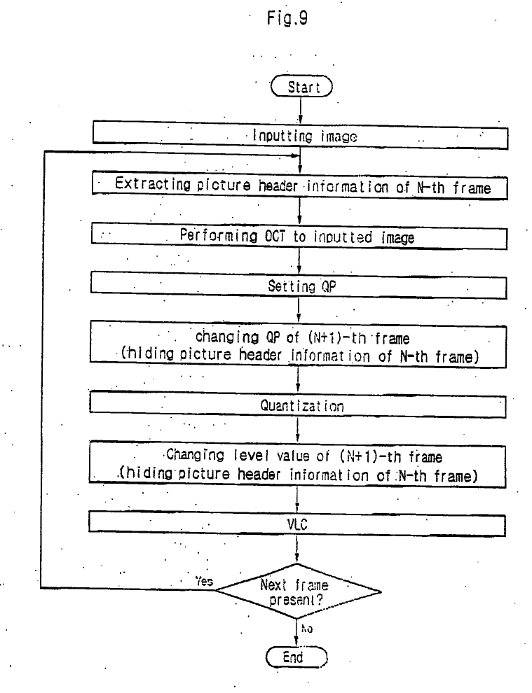

In this manner, the parameter set of the picture header, the “PQUANT” value and the “temporal reference” value are transmitted as the important framework information of the picture header through the data hiding technology. A total of 11 bits are used to transmit all of the parameter set, the “PQUANT” value and the “temporal reference” value. The structure of the picture header information is shown in FIG. 8.

Meanwhile, when the data hiding is performed using the picture header information, it is achieved after one frame ((N+1)-th frame). Since the picture header is an information located at the head of the encoding picture, if the picture header information is hidden in the corresponding picture (N-th frame), the picture header information cannot be extracted when an error occurs in the picture header.

Accordingly, the picture header information is hidden in next frame and is transmitted. If an error occurs in the picture header, the corresponding picture is stored in a buffer without being decoded. If the next frame is transmitted and decoded correctly, the picture header information of the previous frame is extracted and then the picture stored in the buffer is normally decoded using the extracted picture header information.

At this point, a picture received after the picture having the picture header, in which an error occurs, is decoded using an incorrect reference frame because its own reference frame is not decoded. Therefore, if the previous frame is normally decoded, the decoding is performed once again using the frame.

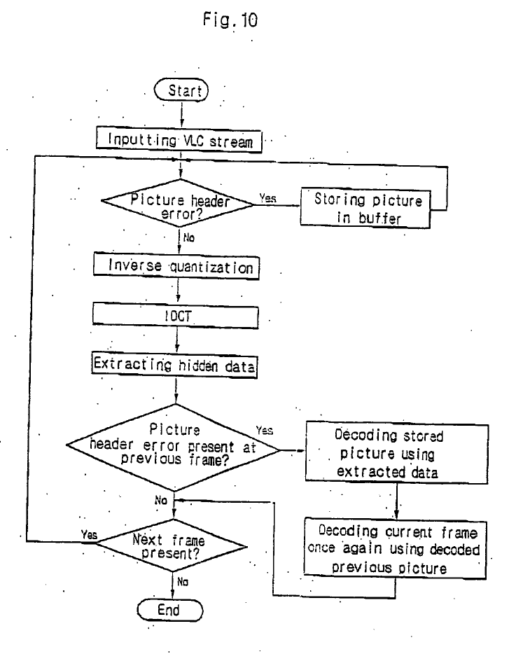

FIGS. 9 and 10 are flowcharts illustrating the coding process of the encoder and the decoder, respectively.

Meanwhile, an error rate in the moving picture communication is differently changed depending on environments. The error rate is 10E-3 in a serious case and there is an environment having almost no error. In an environment having high error rate, the hiding data must be repeatedly transmitted several times since the data may be broken due to the error. If there occurs an error in the reconstructing data, the hidden data is extracted and the error is concealed. Since the data hiding itself is hidden in the encoding bit stream, the hidden data is also broken if the encoded data is broken due to the error.

If the error concealment is performed using the broken information, the degradation of the picture quality becomes more serious. Therefore, the data to be hidden are repeatedly transmitted several times. In this manner, even when the hidden data is broken due to the error, the other data repeated can be used at the decoder.

In case of the related art error concealment method, the image is reconstructed maximally similar to the original image using only the received image at the decoder. In other words, since available information is limited, there is a difference between the reconstructed image and the original image. The general video compression is performed using the difference value from the previous image. Therefore, once an error occurs at a specific time point, the error is propagated to next images as long as the error is not removed perfectly in other words, it is necessary to remove the error extremely.

The moving picture coding method according to the present invention can remove the error extremely because the error concealment is performed using the additional information at both the receiver and the transmitter.

The moving picture coding method according to the present invention provides more efficient error concealment when the error occurs in the video communication such as IMT-2000. Thus, the moving picture coding method can be effectively used in the moving picture communication services, which employ general video codec standard (H.26X, MPEG 1, 2, 4).

According to the present invention, when the multimedia images are transmitted through the network, the error concealment can be efficiently processed with respect to the error occurring in the decoding process by providing the picture header information through the data hiding in the encoding process.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A moving picture coding method of a moving picture transmission system, comprising the steps of:
extracting a picture header information of an inputted image at an encoder;
transmitting the extracted picture header information through data hiding; and
performing an error concealment using the transmitted picture header information at a decoder.

2. The moving picture coding method according to claim 1, further comprising the step of extracting the picture header information from the data hiding at the decoder before tine error concealment is performed.

3. The moving picture coding method according to claim 1, wherein the picture header information includes a structural information of encoding picture header and a header information that changes every time in an encoding process.

4. The moving picture coding method according to claim 3, wherein the structural information of the encoding picture header includes an information about whether the picture header is extended or not.

5. The moving picture coding method according to claim 3, wherein the header information that changes every time in the encoding process includes quantization parameter (PQUANT) of a corresponding picture and a temporal reference value, the temporal reference value being a picture information to which the corresponding picture refers.

6. The moving picture coding method according to claim 1, wherein the data hiding repeatedly hides the picture header information two or more times.

7. The moving picture coding method according to claim 1, wherein the data hiding is performed using a quantization parameter with respect to the inputted image and/or a level value of a block in which DCT (discrete cosine transform) is performed.

8. The moving picture coding method according to claim 7, wherein the level value is given by dividing DCT coefficient by the quantization parameter.

9. The moving picture coding method according to claim 1, wherein the data hiding hides the extracted picture header information in next frame from a frame which the picture header information is extracted from.

10. The moving picture coding method according to claim 1, wherein the error concealment includes the steps of:
checking whether or not an error occurs in the picture header of an inputted N-th frame;
if the error occurs in the picture header of the inputted N-the frame, storing corresponding picture data in a buffer, and decoding picture data of a (N+1)-th frame to extract a picture header information of the N-th frame; and
decoding the picture data of the N-th frame with reference to the extracted picture header information of the N-th frame, the picture data of the N-th frame being stored in the buffer.

11. The moving picture coding method according to claim 10, further comprising the steps of decoding the picture data of the (N+1)-th frame with reference to the N-th frame after decoding the picture data of the N-th frame.
